(19) United States
(12) Patent Application Publication
(10) Pub. No.: US 2026/0030437 A1
(43) Pub. Date: Jan. 29, 2026

(54) SYSTEM AND METHOD FOR DEEP LINKING TO BOOKMARKS

(71) Applicant: Open Text SA ULC, Halifax (CA)

(72) Inventors: Gary Clayton COWAN, Tallahassee, FL (US); Brett CONLEY, Smithfield, UT (US)

(21) Appl. No.: 18/787,821

(22) Filed: Jul. 29, 2024

(51) Int. Cl. G06F 40/169; G06F 40/143

(52) U.S. Cl. CPC G06F 40/169; G06F 40/143

(57) ABSTRACT

Systems, methods and products are disclosed for providing the ability to generate a universal bookmark link that can be generated by an integrating application that enables viewing of client files in many different formats by converting them to a common viewing format. The universal bookmark link can be provided to users who are external to the viewing application, and the users can access the link to open an instance of the application and viewer, load the publication of the file, and position the viewer at the location of the linked bookmark.

### TECHNICAL FIELD

This disclosure relates generally to bookmarks, and more specifically to systems and methods for generating and processing links to document bookmarks for disparate document formats that have been converted to a viewing format, such as scalable vector graphics (SVG).

### BACKGROUND

Intelligent viewing systems may be used with content management systems to enable a customer's files (which may be in many different formats) to be viewed in conjunction with each other in a single viewer. In some cases, this requires that the customer's files be converted from their original formats (e.g., pdf, dwg, docx, xlsx, pptx, etc.) to a common viewing format, such as SVG.

The customer's files may include bookmarks that may be lost or corrupted when the files are converted for viewing. The inability to use these bookmarks may make it difficult for users working on the files to collaborate with each other. The disclosed embodiments therefore provide systems and methods for users to generate links to bookmarked portions of the viewable conversions of customer's files, where users external to the intelligent viewing system can click on the links to instantiate an instance of the viewer to view converted versions of the associated customer files and repositioning the viewer to view specific pages and locations in the converted files as indicated by the links.

### SUMMARY

A method is provided for generating a universally accessible bookmark, the method including loading in a viewer of an integrating application a document, the loading including converting the document from one of a first plurality of formats to a viewing format, loading in the viewer of the integrating application a set of bookmarks that are defined in the document, triggering a bookmark link event for a selected bookmark of the set of bookmarks, in response to the link event, generating a link, the link identifying a domain of the integrating application, the document, and one or more bookmark parameters associated with the selected bookmark, and sending the bookmark link to a user external to the domain of the integrating application.

Another embodiment provides a method for accessing a universal bookmark link, the method including receiving, from a requesting user, a request to open an instance of an integrating application using a bookmark link, the link identifying a domain of the integrating application, a document, and one or more bookmark parameters associated with a selected bookmark in the document, building a bookmark location parameter object based on a link structure of the bookmark link, loading the document in a viewer of the instance of the integrating application, the loading including converting the document from one of a first plurality of formats to a viewing format, loading in the viewer of the integrating application a set of bookmarks that are defined in the document, searching for the selected bookmark in the set of bookmarks, and in response to finding the selected bookmark in the set of bookmarks, identifying a page and a rectangle in the viewing format of the document, scrolling the viewer to the identified page and rectangle, and displaying the identified page and rectangle to the requesting user in the viewer.

Numerous alternative embodiments may also be possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1A depicts a flow diagram illustrating a high level method for accessing and converting client files for display by a viewer of an integrating application.

FIG. 1B depicts a flow diagram illustrating a high level method for generating a universal bookmark link.

FIG. 1C depicts a flow diagram illustrating a high level method for accessing a universal bookmark link.

FIG. 2 depicts a diagram illustrating the architecture of an example system in which some disclosed embodiments can be implemented.

FIG. 3 depicts a sequence diagram illustrating one example of a process for bookmark link generation.

FIGS. 4A-4B together depict a sequence diagram illustrating one example of a process for bookmark link processing.

FIG. 5 depicts a screenshot showing an example of a user interface of a viewer.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein address the problems discussed above by providing a means to generate a universal bookmark link that can be generated by an integrating application that enables viewing of client files in many different formats by converting them to a common viewing format, such as scalable vector graphics (SVG). Client files can be converted from various original formats (e.g., pdf, dwg, docx, xlsx, pptx, etc.) to any desired common viewing format. The universal bookmark link can be provided to users who are external to the viewing application, and these users can access the link to open an instance of the application and viewer, load the publication (e.g., SVG image) of the file, and position the viewer at the location of the linked bookmark.

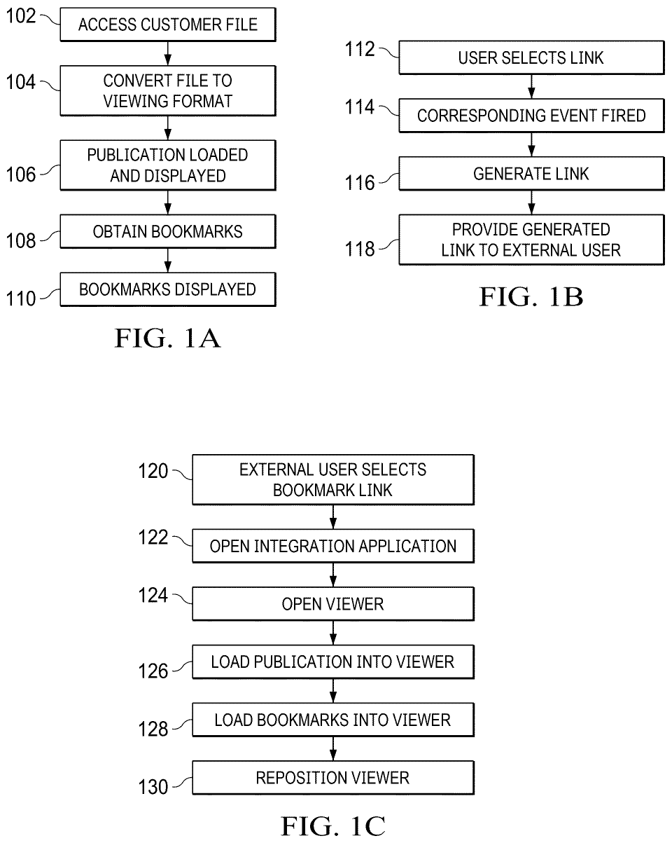

Referring to FIG. 1A, a flow diagram is shown to illustrate a high level method for accessing and converting client files for display by the viewer of an integrating application. At step 102, the integrating application accesses a customer file (e.g., in a content management system). The files that are accessed by the integrating application may have many different formats. At step 104, the particular file that is selected for viewing is converted to a viewing format used by the viewer of the integrating application. In one particular example, the viewing format is SVG. The SVG image of the customer file may be referred to as a publication of the file. The publication may be stored by the system for later use.

At step 106, the publication is loaded by the viewer of the integrating application and is displayed to a user. The customer file from which the publication is generated may have bookmarks associated with it, so at step 108, the bookmarks for the customer file are obtained. At step 110, the bookmarks are displayed to the user in the viewer of the integrating application.

Referring to FIG. 1B, a flow diagram is shown to illustrate a high level method for generating a universal bookmark link in accordance with some embodiments. When the publication of the client file and the associated bookmarks are presented in the viewer, a link button is presented next to each bookmark. At step 112, a user of the integrating application who is viewing the publication of the client file and the associated bookmarks clicks on the link button, the corresponding event is fired by the integrating application (step 114). When this event is fired, the application generates (at step 116) a link that identifies the integrating application, the publication and the bookmark. At step 118, the user provides the generated link to someone who may be an external user and does not have direct access to the integrating application.

Referring to FIG. 1C, a flow diagram is shown to illustrate a high level method for accessing a universal bookmark link in accordance with some embodiments. At step 120, an external user to whom the bookmark link has been sent clicks on the link. At step 122, an instance of the integrating application, which is identified in the link, is opened for the external user. At step 124, a viewer is opened within the integrating application. Then, at step 126, the publication, which is also identified in the link is loaded into the viewer. The bookmarks associated with the publication or then also loaded into the viewer (step 128) and the viewer is repositioned to view the specific location in the publication which corresponds to the bookmark identified in the link (step 130).

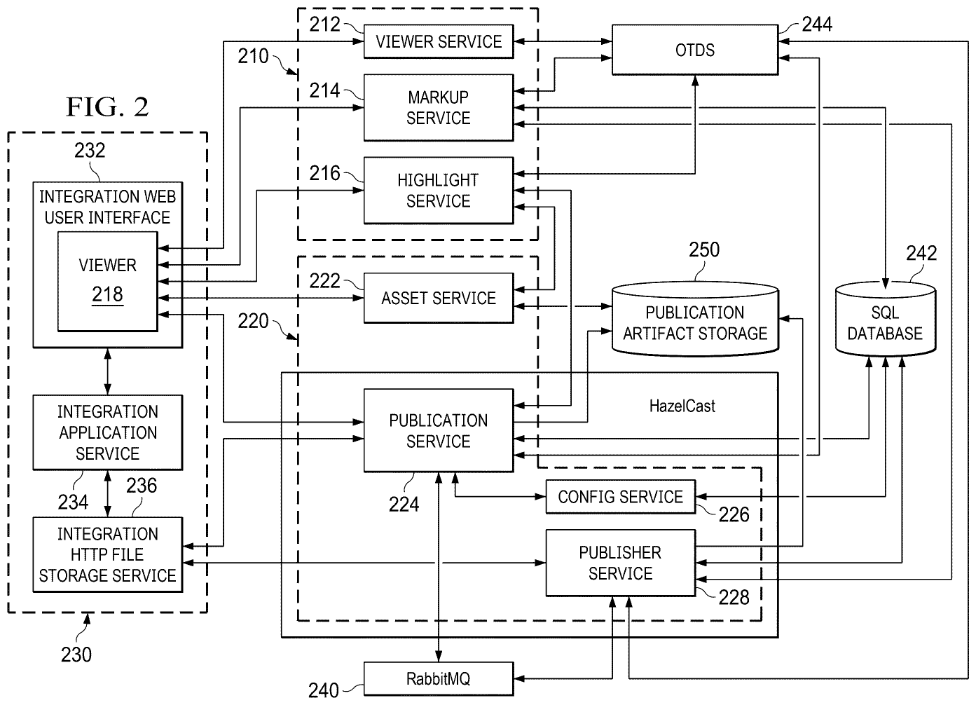

Referring to FIG. 2, a diagram is shown to illustrate the architecture of an example system in which some disclosed embodiments can be implemented. In this architecture diagram, a first set 210 of components comprise viewing services (viewer service 212, markup service 214, highlight service 216, viewer 218), while a second set 220 of components comprise transformation services (asset service 222, publication service 224, config service 226, publisher service 228), and a third set 230 of components comprise an integrating application (integration application service 234, integration HTTP file storage service 236). Several additional components that are contained in the system will be described in more detail below.

The integrating application components (set 230) are intended to integrate the various other services to enable users to view the client files. The integration web user interface 232 provides an application interface for users. The integration application service 234 serves up the application interface 232 and handles all of the API work for the integrating application. The integration HTTP file storage service 236 provides HTTP access to the content (e.g., within a content management service, etc.).

The viewing components (set 210) are intended to present publications or images of the client files to the viewer in a common format. The markup service 214 enables the ability of a user, within the viewer 218, to make annotations (e.g., draw shapes, OK content, make redactions, etc.) to the content that the user is viewing. The markup service 214 provides a CRUD (create, read, update, and delete) service that that manages the persistence of the annotations. The highlight service 216 can be thought of as a conduit service between the viewer 218 and the search, bookmark, and text information generated during the transformation process, enabling the viewer 218 to perform in document searching of keywords, get bookmark information. perform text comparisons, etc.

The transformation components (set 220) are intended to transform the client files in order to prepare them for viewing by the viewer. The asset service 222 facilitates access by the viewer 218 to stored thumbnail images and SVG renderings. The publication service 224 and the publisher service 228 both can make calls into the integration HTTP file storage service 236. The publication service 224 can make requests using the authenticated user's token to ensure that the user has access to the content, and then the publisher service 224 downloads the content from this storage location so it can be processed. The SQL database 242 is used statically by the config service 226 to store feature and profile information that's used to construct the transformation job. The publication service 224 uses the SQL database 242 to store the job structure and the incoming request data. The SQL database 242 is also used by the markup service 214 for storing annotation information.

In some embodiments, such as the example shown in FIG. 2, functionality of the publication service 224, config service 226, and publisher service 228 can be provided by a distributed computing framework 246 for managing processing data across multiple nodes. In some embodiments, such a framework 246 can be provided by Hazelcast, an open-source in-memory data grid. Other examples are also possible, as one skilled in the art would understand.

An OTDS 244 serves as an authentication provider for providing a centralized service for handling user credentials and access rights, making it easier to manage and secure access to various applications and services. In some embodiments, authentication functionality can be provided by a system such as OpenText Directory Services (OTDS), although other systems could be used, as one skilled in the art would understand.

When a user of an integrating application initiates the upload of a client file into viewer 218, which is open in application interface 232, the system begins a transformation process on the file. Application interface 232 will make a post-call to publication service 224. The call identifies the URL of the source file that the user wishes to upload for viewing and requests that the identified file be transformed to a particular format that can be viewed in the viewer. In this example, the file is transformed to an SVG format.

Publication service 224 coordinates with config service 226 to build up a transformation job in the form of a JSON object. The transformation job object includes a description of the transformation job to be performed. When the transformation job object is complete, publication service 224 will post the job to a message queue 240. In this particular example, the RabbitMQ message service is used to post the job.

Publisher service 228 is subscribed to message service 240, and as soon as the transformation job is posted on the message service, the publisher service will pick up the job. Publisher service 228 will then download the source file and will begin running the transformation process which is defined in the job description object. As part of this process, the publisher service in this example will generate a thumbnail image for each page of the source file, as well as an SVG rendering of each page in the file. The thumbnail images and SVG renderings of the pages of the file will then be stored on disk 250, in this example. The stored thumbnail images and SVG renderings in disk 250 can then be accessed by viewer 218 through asset service 222.

Once the transformation process on the selected customer file has been completed, the converted file is opened in viewer 218 in application interface 232. Viewer 218 will call into highlight service 216 to request all of the bookmark metadata for the document. Highlight service 216 will then pull the bookmark metadata from a file where it was stored (e.g., on disk 250) during the transformation process. The bookmark metadata will then be returned to viewer 218. At this point, viewer 218 has all of the pages of the document (or potentially a subset of pages if the number of pages is large), as well as the thumbnails and the bookmark information for the document. The viewer can therefore display this information to the user.

In some embodiments, the tree of bookmarks for the document is displayed to the user. Additionally, the viewer displays a button next to each one of the bookmarks. If the user clicks a button next to a particular bookmark, the viewer 218 here will fire an event which is caught by the integration web user interface 232, which will then generate the link and will pass this link to the user (e.g., embed it in another file, e-mail it, etc.). With respect to other users, another user can click on that link and it will come into the integration Web user interface 232, which will take the link and make an API call into the viewer 218 and the viewer 218 will then navigate within the document to that specific location Within the document.

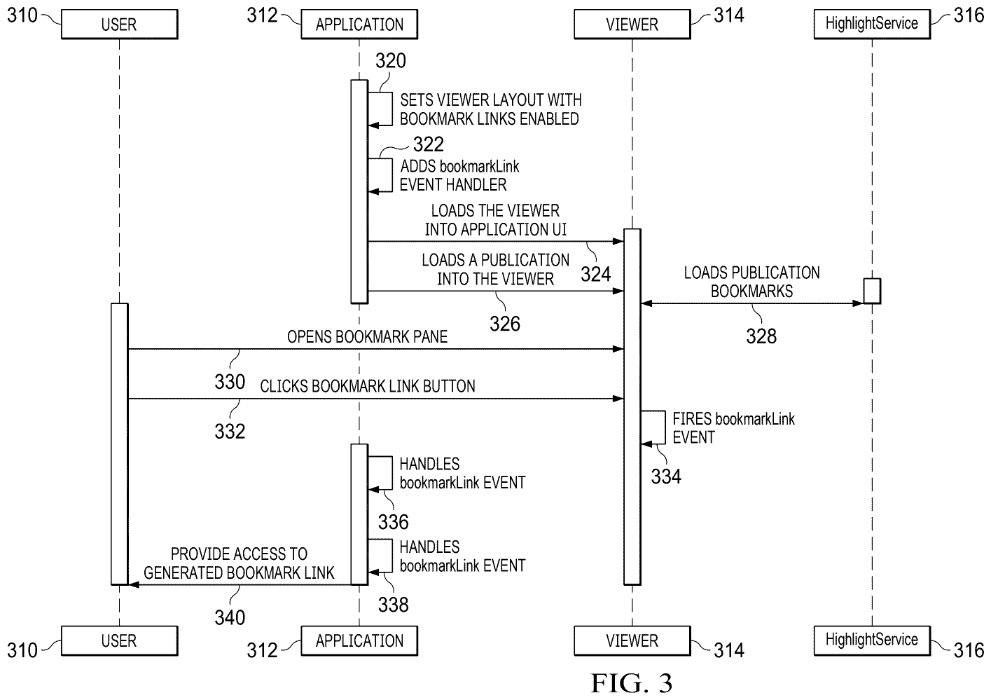

FIG. 3 is a is a sequence diagram illustrating one example of a process for bookmark link generation. FIG. 3 illustrations interactions between a user 310, an application 312, a viewer 314, and a highlight service 316 (e.g., such as highlight service 216, discussed above). One example of an application 312 is a content server application. For example, Documentum is an enterprise content management (ECM) platform developed by OpenText. One example of a viewer 314 is Intelligent Viewer, a cloud-first, universal file viewer developed by OpenText. Other applications and viewers may also be used, as one skilled in the art would understand.

When the application 312 starts up, it initializes the viewer 314. For example, the application 312 sets the view layout with bookmark links enabled (320). The application 312 also adds event handlers for the bookmark links that the viewer will fire (322). The application 312 then loads the viewer 314 into it's the application 312 user interface (324). Next, the application 312 loads a publication (e.g., content/document, etc., in combination with other information such as links of thumbnails and SVG pages files, etc.) into the viewer 314 (326). Note that, in this sequence diagram example, the transformation process has already occurred, and the application 312 has the publication that a user wants to view in the viewer 314. Also note that, the loaded publication (and other loaded publications) can comprise many different document formats, and as described above, the universal bookmark links ultimately generated are generated regardless of the publication format. The viewer 314 then calls the highlight service 316 and loads the publication bookmarks received from the highlight service 316 (328). The highlight service 316 puts together the bookmark information, including metadata for each individual bookmark, etc., and provides that to the viewer 314. The viewer 314 is then able to display the publication information in a tree of publication bookmarks, for example. In some embodiments, the publication has an associated JSON object loaded into the viewer 314 that contains information about the publication, although it may not contain all of the data associated with the publication. The JSON object may include a name, a UUID identifier, publication ID, and the geometry information (e.g., a rectangle) of where the bookmark actually is in the document. When the link is processed, this is where the viewer navigates (e.g., to a combination of a page number and the rectangle).

When the user 310 opens the content visible in the viewer 314, the viewer 314 will open a bookmark pane (330), where the user may click on a button next to a bookmark (332). Next, a bookmark link event is fired (334) by the viewer 314. The bookmark link event is then handled by the application 312 (336), and the bookmark link is generated (338). Finally, access to the generated bookmark link is provided to the user (340).

In some embodiments, a user is able to view multiple documents and their respective bookmarks on the same screen. Not only can the user select bookmarks for a specific document, but can select bookmarks for multiple documents on the same user interface.

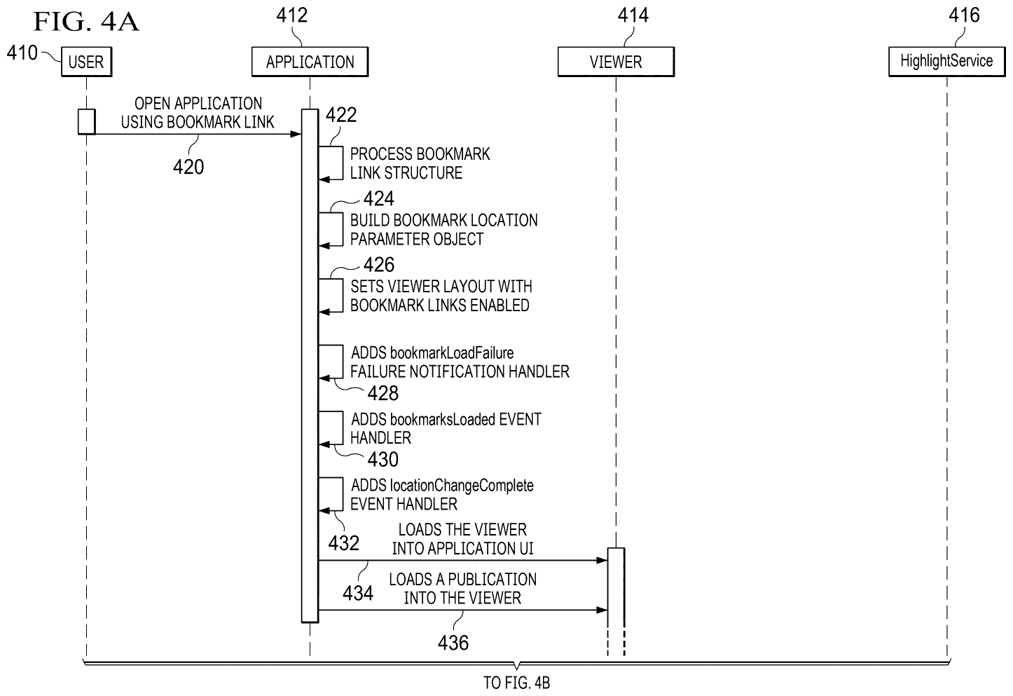

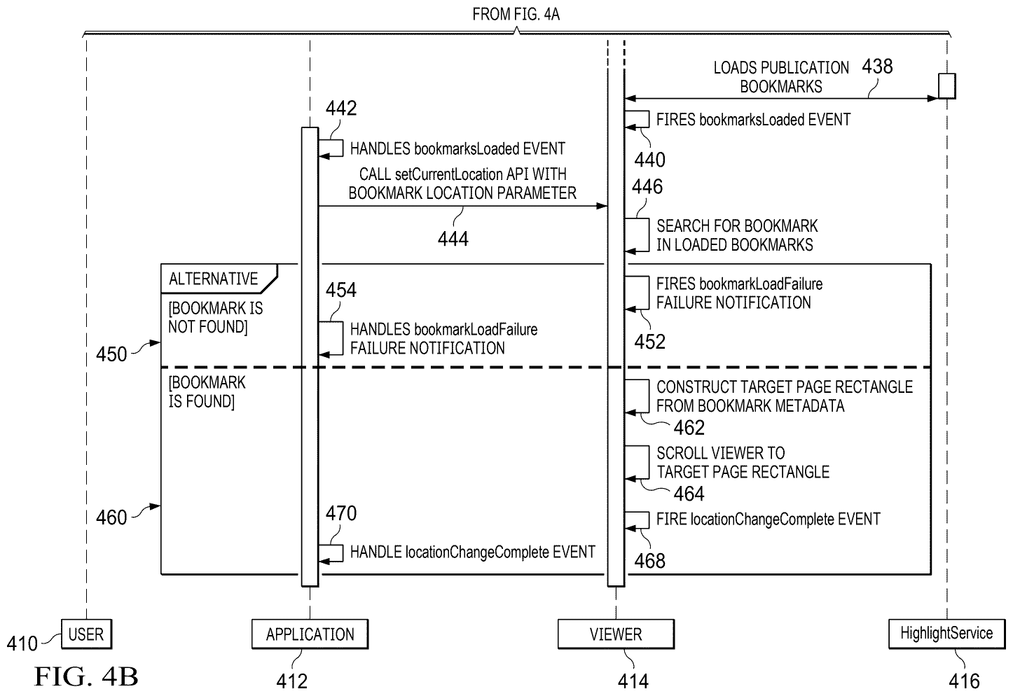

FIG. 4 is a is a sequence diagram illustrating one example for bookmark link processing. Note that FIG. 4 is spit across two pages as FIGS. 4A and 4B. As in FIG. 3, FIG. 4 illustrations interactions between a user 410, an application 412, a viewer 414, and a highlight service 416.

When the user 410 clicks the bookmark link button (420), the application 412 opens. Note that, as shown in FIG. 3, when the user 310 clicks the bookmark link button (332), the viewer 314 fired a bookmark link event (334), which is then captured by the integrating application. Note that once the link is generated, a subsequent user would not have to have access to the application to user the link, as is more clearly shown in FIG. 3.

As shown in FIG. 4, when the user 410 opens the application with the bookmark link (420), the application 412 processes the bookmark link structure (422). The application 412 then builds the bookmark location parameter object (424), which, in some embodiments, may be a small JSON object that includes the type value (e.g., type=bookmark). At 426, the application sets the viewer layout with bookmark links enabled. The application 412 also adds some event (notification) handlers for the bookmarkLoadFailure (428), adds a bookmarksLoaded event handler (430), and adds a locationChangeComplete event handler (432).

At 434, the application 412 loads/embeds the viewer into its user interface (434) and, as before, loads the publication/document into the viewer 414. At 438, the viewer 414 loads the publication bookmarks from the highlight service 416. At 440, the viewer 414 fires a bookmarksLoaded event to let the application 412 know that all of the bookmarks have been loaded into memory.

The application 412 handles the bookmarkLoaded event (442) and calls the setCurrentLocation API (444) of the viewer 414 with the small JSON object that it previously generated (424) with the link type (e.g., bookmark) and name. Next, at 446, the viewer 414 takes the parameters from the setCurrentLocation API call and looks at the bookmark metadata that it has loaded to search for the bookmark in the loaded bookmarks. Depending on whether the bookmark was found or not, the process branches into two alternative paths 450 and 460.

If the bookmark was not found (path 450), the viewer 414 fires a bookmarkLoadFailure failure notification (452), and the application 412 handles the failure notification. If the bookmark was found (path 460), the viewer 414 uses the bookmark metadata to construct the target rectangle for the specific page that it refers to (462) and then it scrolls the viewer 414 to that specific page and rectangle (464) and fires a locationChangeComplete event (468) to notify the application 412 that process is complete. The application 412 handles the locationChangeComplete event (470).

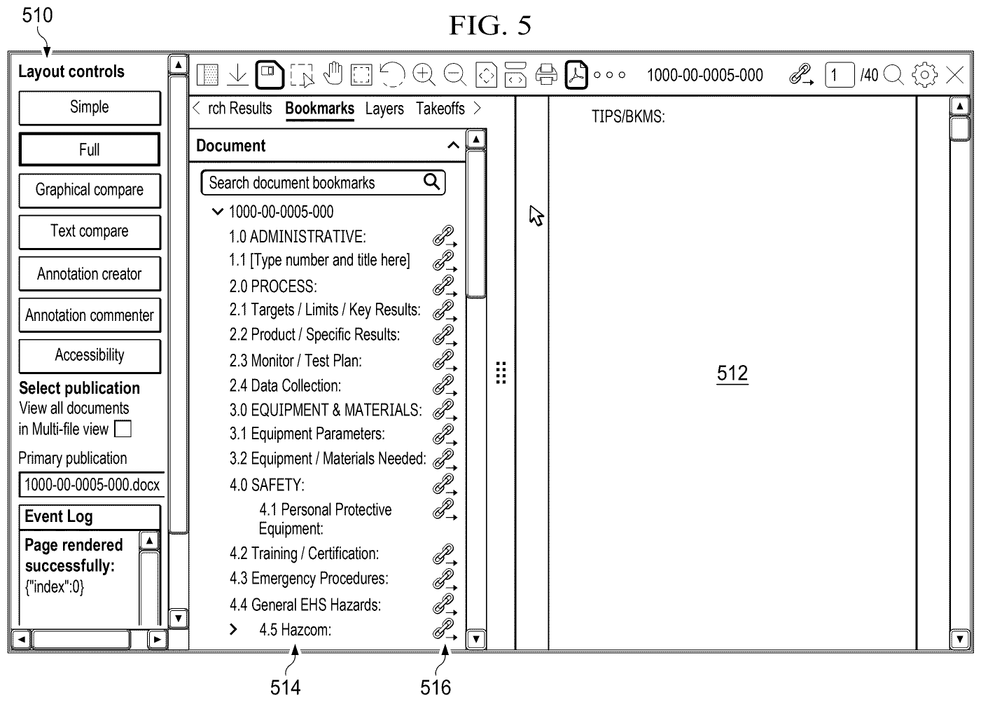

FIG. 5 is a screenshot showing an example of a user interface of a viewer. In this example, the view is Intelligent Viewer (discussed above). The user interface of FIG. 5 includes a side panel 510 that includes a layout controls menu and a publication selection menu. In this example, the user can select various layout controls, including the currently selected “Full” view. The publication selection menu enables a user to select one or multiple publications/documents. In the example shown, a single document titled “1000-00-0005-000.docx” is selected. A view panel 512 is capable of displaying various items, depending on user selections. A bookmarks tab 514 is shown selected, and lists various bookmarks of the selected document. If a user had checked the “View all documents in Multi-file view” checkbox in the side panel 510, the bookmarks list would include bookmarks from all of the selected documents. When a user selects one of the bookmark buttons 516, the viewer would display the portion of the document indicating to the selected bookmark in the view panel 512. The view shown in FIG. 5 is capable of numerous other displays and configurations, as one skilled in the art would understand. Also note that other viewers can also be used with the concepts described herein, as FIG. 5 is merely one example.

Embodiments of the technology may be implemented on a computing system. Any suitable combination of mobile desktop, server machine, embedded or other types of hardware may be used. One exemplary embodiment may be implemented in a distributed network computing environment. The computing environment in this embodiment may include a client computer system and a server computer system connected to a network (e.g., a local area network (LAN), a wide area network (WAN) such as the Internet, mobile network, or other type of network or combination thereof). The network may represent a combination of wired and wireless networks that network computing environment may utilize for various types of network communications.

The computer systems may include, for example, a computer processor and associated memory. The computer processor may be an integrated circuit for processing instructions, such as, but not limited to a CPU. For example, the processor may comprise one or more cores or micro-cores of a processor. The memory may include volatile memory, non-volatile memory, semi-volatile memory or a combination thereof. The memory, for example, may include RAM, ROM, flash memory, a hard disk drive, a solid-state drive, an optical storage medium (e.g., CD-ROM), or other computer readable memory or combination thereof. The memory may implement a storage hierarchy that includes cache memory, primary memory or secondary memory. In some embodiments, the memory may include storage space on a data storage array. The client computer system may also include input/output (“I/O”) devices, such as a keyboard, monitor, printer, electronic pointing device (e.g., mouse, trackball, stylus, etc.), or the like. The client computer system may also include a communication interface, such as a network interface card, to interface with the network.

The memory may store instructions executable by the processor. For example, the memory may include an operating system, a page editing or processing program (e.g., a web browser or other program capable of rendering pages), a server program configured to extend the functionality of the page processing program or other server code. Further, the memory may be configured with a page processable (e.g., capable of being rendered by) by the page editing program. The page may be the local representation of a page, such as a web page, retrieved from the network environment. As will be appreciated, while rendering the page, the page editing/processing program may request related resources, such as style sheets, image files, video files, audio files and other related resources as the page is being rendered and thus, code and other resources of the page may be added to the page as it is being rendered. Application server code can be executable to receive requests from client computers, generate server page files from a set of page assets (e.g., complete web pages, page fragments, scripts or other assets) and return page files in response. A page file may reference additional resources, such as style sheets, images, videos, audio, scripts or other resources at a server computer system or at other network locations, such as at additional server systems.

According to some embodiments, a network environment may be configured with a page such as a web page which is configured to launch and connect to an instance of the server program. The page may include a page file containing page code (HTML or other markup language, scripts or code), stored or generated by the server computer system, that references resources at the server computer system or other network locations, such as additional server computer systems. The page file or related resources may include scripts or other code executable to launch and connect to an instance of the server program.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any, hardware system, hardware mechanism or hardware component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A method for generating a universally accessible bookmark, the method comprising:
loading in a viewer of an integrating application a document, the loading including converting the document from one of a first plurality of formats to a viewing format;
loading in the viewer of the integrating application a set of bookmarks that are defined in the document;
triggering a bookmark link event for a selected bookmark of the set of bookmarks;
in response to the link event, generating a link, the link identifying a domain of the integrating application, the document, and one or more bookmark parameters associated with the selected bookmark; and
sending the bookmark link to a user external to the domain of the integrating application.

2. The method of claim 1, wherein the viewing format comprises a scalable vector graphics (SVG) format.

3. The method of claim 1, wherein the one or more bookmark parameters associated with the selected bookmark comprise a bookmark name, the bookmark name being contained in the set of bookmarks that are defined in the document.

4. The method of claim 1, wherein the one or more bookmark parameters associated with the selected bookmark identifies a page of the document.

5. The method of claim 4, wherein the one or more bookmark parameters associated with the selected bookmark identifies a geometry information identifying a location in the identified page of the document.

6. The method of claim 4, wherein the geometry information comprises a rectangle identifying the location in the identified page of the document.

7. The method of claim 1, further comprising receiving user input identifying the selected bookmark, wherein the bookmark link event is triggered in response to user input selecting a link indicator associated with the selected bookmark.

8. The method of claim 1, wherein the first plurality of formats do not comprise the viewing format.

9. The method of claim 1, further comprising loading in the viewer of the integrating application a plurality of documents and converting the plurality of documents from one of a first plurality of formats to the viewing format.

10. The method of claim 1, further comprising loading in the viewer of the integrating application a set of bookmarks for each of the plurality of documents that are defined in the respective documents.

11. A method for accessing a universal bookmark link, the method comprising:
receiving, from a requesting user, a request to open an instance of an integrating application using a bookmark link, the link identifying a domain of the integrating application, a document, and one or more bookmark parameters associated with a selected bookmark in the document;
building a bookmark location parameter object based on a link structure of the bookmark link;
loading the document in a viewer of the instance of the integrating application, the loading including converting the document from one of a first plurality of formats to a viewing format;
loading in the viewer of the integrating application a set of bookmarks that are defined in the document;
searching for the selected bookmark in the set of bookmarks; and
in response to finding the selected bookmark in the set of bookmarks, identifying a page and a rectangle in the viewing format of the document, scrolling the viewer to the identified page and rectangle, and displaying the identified page and rectangle to the requesting user in the viewer.

12. The method of claim 11, further comprising, in response to not finding the selected bookmark in the set of bookmarks, generating a bookmark link failure notification.

13. The method of claim 11, wherein searching for the selected bookmark in the set of bookmarks comprises making an API call to set a viewing location in the document in the viewer of the integrating application, the API call based on the bookmark location parameter object.

14. The method of claim 11, wherein information associated with the document and the set of bookmarks are provided to the viewer of the integrating application in corresponding JSON objects.

15. The method of claim 11, wherein in response to receiving the request to open the instance of the integrating application, the instance of the integrating application is opened and one or more handlers that process events associated with the set of bookmarks are loaded by the instance of the integrating application.

16. The method of claim 11, further comprising loading a plurality of documents in the viewer of the instance of the integrating application, the loading including converting each of the documents from one of the first plurality of formats to the viewing format.

17. The method of claim 16, wherein loading in the viewer of the integrating application a set of bookmarks that are defined in the document further comprises loading in the viewer of the integrating application a set of bookmarks for each of the plurality of documents that are defined in the respective document.

18. The method of claim 17, wherein the bookmark link identifying the document identifies one of the plurality of documents.

19. The method of claim 17, further comprising displaying in the viewer a list of a sub-set of the plurality of documents.

20. The method of claim 19, further comprising displaying a list of bookmarks that includes bookmarks from each of the documents in the sub-set.
